(19) United States
(12) Patent Application Publication
(10) Pub. No.: US 2019/0225404 A1
(43) Pub. Date: Jul. 25, 2019

(54) LABEL FACESTOCK FILM AND METHOD OF MANUFACTURING THE SAME

(71) Applicant: INNOVIA FILMS LIMITED, Wigtort Cumbria (GB)

(72) Inventors: Elizabeth TATLOCK, Wigton Cumbria (GB); Jamie MOFFAT, Wigton Cumbria (GB); Jonathan HEWITT, Wigton Cumbria (GB); Stephen LANGSTAFF, Wigton Cumbria (GB)

(21) Appl. No.: 16/309,038

(22) PCT Filed: Jul. 4, 2017
(86) PCT No.: PCT/GB2017/051966

§ 371 Date: Dec. 11, 2018

(30) Foreign Application Priority Data
Jul. 4, 2016 (GB) 1611621.2

(51) Int. Cl. B65D 81/26; B65D 81/28

(52) U.S. Cl. CPC B65D 81/267; A23B 7/152; B65D 81/28

(57) ABSTRACT

The present invention provides a label facestock film comprising a substrate web and a pattern of material comprising a VOC scavenger on a surface of the substrate web, wherein the pattern of the material comprising a VOC scavenger is repetitive and forms a region of said surface that is free from any material comprising a VOC scavenger.

This application is a national stage application of International Patent Application No. PCT/GB2017/051966, filed Jul. 4, 2017, which claims priority to Great Britain patent Application No. 1611621.2, filed Jul. 4, 2016. The entirety of the aforementioned applications is incorporated herein by reference.

### FIELD

The present invention concerns a label facestock film, as well as a labelstock and label produced using such a film, a packaging including said articles and a method of making said film.

### BACKGROUND

Materials that can modify the environment in which they are placed are important in a number of different applications. For example, such materials can be used in packaging containing organic matter, such as food products, to ensure that a constant environment is maintained.

For example, organic matter can emit volatile organic compounds (VOCs) such as ethylene or trimethylamine. Increased levels of VOCs can affect the quality of the organic matter itself and so removal of VOCs can help to prolong the shelf life and enhance the quality of the organic matter. Unwanted odours can also be eliminated and the colour and/or firmness of the organic matter improved by the removal of VOCs from the environment surrounding the organic matter.

Ethylene is a ripening hormone and so increased levels within a packaging can lead to over-ripening of the organic matter in the packaging. This can reduce the quality of the organic matter and can cause yellowing and peel damage. A number of approaches are currently used to remove ethylene from packaging environments, such as ventilation, chemical techniques, adsorption, photocatalytic methods and chemically catalytic methods.

Sorbents commonly used to remove VOCs by sorption of the VOCs include activated carbon, clays and zeolites. Zeolites are particularly well known as sorbents for removing ethylene and suitable zeolite compositions are disclosed in GB2252968, WO2007/052074 and WO2011/001186. However, zeolites can be poisoned by water.

VOC scavengers and particularly ethylene scavengers are often particulate, and so can be included in a binder before being applied to a substrate. Materials comprising an ethylene scavenger are generally applied as coatings using conventional methods such as aqueous flood coating as shown in, for example, WO2008/110020. This type of coating provides an even coverage of the film and is a well-known technique.

Packages can be made using films that are coated with a material comprising a VOC scavenger. However, this is relatively expensive, as the VOC scavenger is an expensive component of the film and is present over the entire film surface as a result of the flood coating. Alternatively, small structures including a material comprising a VOC scavenger can be placed loose in the packaging. However, such structures can be difficult to see from outside the packaging, are often undesirable to brandowners, retailers and consumers, and may pose a risk of ingestion to the consumer.

WO2008/149232 discloses the inclusion of an ethylene scavenger in an antimicrobial composition, which may be presented as tablets, coatings that can be applied to a substrate, granules that can be packed into sachets and substrates incorporating the composition within their mass. The inclusion of the antimicrobial composition improves the efficiency of the ethylene removal.

U.S. Pat. No. 9,320,288 discloses a composition comprising a complex formed from an olefinic antagonist or inhibitor of receptor sites of ethylene generation in combination with a cyclodextrin compound. The composition may be applied to a substrate, which may be a label.

The use of labels can significantly reduce the cost of a packaging, as it means that the entire packaging structure does not have to include a material that comprises a VOC scavenger. Less VOC scavenger is therefore used, which can significantly reduce the cost, as it is the VOC scavenger that is the most expensive part of the structure. Additionally, the label can be positioned within the structure in order to maximise efficacy and so that it can be easily seen.

However, due to the cost of the VOC scavenger, there is a requirement for a film or label that includes a material comprising a VOC scavenger, but that is less expensive to manufacture.

### BRIEF DESCRIPTION OF THE DRAWINGS

The invention will now be more particularly described with reference to the following figures, in which:

FIG. 1 illustrates a possible facestock film layer arrangement, in the region of the substrate surface that comprises the material comprising a VOC scavenger;

FIG. 2 illustrates a larger section of the facestock film, showing the regions of the substrate surface both with and without the material comprising a VOC scavenger;

FIG. 3a illustrates a first embodiment of a region of the substrate surface comprising the material comprising a VOC scavenger, wherein the material comprising a VOC scavenger consists of VOC scavenger particles and a binder;

FIG. 3b illustrates a second embodiment of a region of the substrate surface comprising the material comprising a VOC scavenger, wherein the material comprising a VOC scavenger consists of VOC scavenger particles and a binder; and

FIG. 4 illustrates a printed film according to the embodiment of the invention disclosed in Example 2.

### DETAILED DESCRIPTION

According to the present invention there is provided a label facestock film comprising a substrate web and a pattern of material comprising a VOC scavenger on a surface of the substrate web, wherein the pattern of the material comprising a VOC scavenger is repetitive and forms a region of said surface that is free from any material comprising the VOC scavenger.

Having a region of the substrate surface that is free from any material comprising a VOC scavenger reduces the overall amount of VOC scavenger used in the facestock film and therefore also used in the labels created from the facestock film. As it is the VOC scavenger that is the expensive component of the facestock film, this can significantly decrease the cost of the facestock film.

Used herein, “VOC scavenger” refers to a component that is able to remove a VOC from an environment with which it is in contact. The VOC may be removed from the environment by any effective means, such as adsorption, absorption or chemical modification of the VOC. The VOC in the environment may have been emitted from organic matter contained within the environment. The environment may have a modified or an unmodified atmosphere.

Used herein, a “web” refers to a continuous length of film that can be wound onto a reel. A “facestock” refers to the film that is used to produce the labels before the labels have been cut and does not include a release liner. A “labelstock” comprises the facestock and a release liner.

The formation of labels from a facestock film or a labelstock involves cutting the film at regular intervals in order to create the labels. The cuts are generally made around one or more label-forming regions, to create labels that can be removed from the rest of the film. This involves the creation of a matrix in addition to the labels, the matrix consisting of the parts of the facestock film that surround the labels but do not form the labels themselves. The matrix is therefore waste produced during the label manufacturing process.

The label facestock film may therefore comprise one or more label-forming regions and one or more matrix regions. The label-forming regions are the regions that are intended to form a label. The matrix regions are the regions surrounding the label-forming regions, which are not intended to form a label.

The matrix regions and the label-forming regions will ultimately be defined by cutting the substrate during the formation of the labels. Methods of cutting labels, such as die cutting, are well known in the art. However, the region of the facestock film at which one or more cuts are made during the formation of the labels, and/or the matrix region, may be determined during the creation of the facestock film itself, before the cuts are made. For example, components such as any ink that is applied to the facestock film can define the label-forming regions and the matrix regions.

The region of the substrate surface that is free from any material comprising a VOC scavenger may at least partly overlap with the region of the facestock film at which one or more cuts are made during the formation of the labels. The region of the facestock film at which cuts are made during the formation of the labels may comprise or consist of the matrix region of the substrate. The region of the substrate surface that is free from any material comprising a VOC scavenger may at least partly overlap with the matrix region.

Including a region of substrate surface that does not include a material comprising a VOC scavenger in the region of the facestock film in which the cuts are made during the production of labels, or in the matrix region of the facestock film, means that less VOC scavenger is lost as waste during the process of creating labels from the facestock film. As it is the VOC scavenger that is the expensive component of the label, reducing the amount that is wasted can significantly reduce the overall cost of producing the labels.

The pattern of the material comprising a VOC scavenger may be repetitive such that it repeats at intervals that correspond to the intervals between the labels formed from the facestock film and/or the intervals between the label-forming regions. Thus, each of the labels formed from the facestock film may comprise an isolated region of material comprising the VOC scavenger. This means that the material comprising the VOC scavenger can create two patterns. The first pattern is formed from the repetition of the regions of material comprising the VOC scavenger at intervals that correspond to the intervals between the labels, thereby forming a pattern of regions of material over the facestock film. Each region of material may correspond to a single label-forming region. However, the material comprising the VOC scavenger may also be patterned within each region on each label, thereby creating a second pattern. Each region of the material comprising the VOC scavenger on each label-forming region may have the same or a different pattern.

Alternatively, the intervals between the labels formed from the facestock film and the repeats of the regions of the material comprising a VOC scavenger may not align. Each of the labels formed from the facestock film may therefore have different patterns of the material comprising a VOC scavenger.

The region of the substrate surface that is free from any material comprising a VOC scavenger is created by the pattern of the material on the substrate surface. Methods of creating a pattern on a substrate surface are well known in the art. For example, the material comprising a VOC scavenger may be printed on the substrate surface, using flexographic printing or other printing methods known in the art.

The use of a pattern of a material comprising a VOC scavenger can increase the surface area of the material comprising a VOC scavenger. The pattern can therefore be selected to increase the surface area of the material comprising a VOC scavenger. This means that more of the material comprising a VOC scavenger is in contact with the environment with which it interacts, which will increase the efficiency of the reaction between the VOC scavenger and the environment, such as ethylene scavenging.

The pattern can also create a tailored loading of the material comprising a VOC scavenger to suit specific end applications, based on factors such as print area. For example, the pattern may be denser, i.e. have more VOC scavenger per unit area, in some regions of the facestock film or label than in other regions.

The pattern may be a uniform pattern, such as crosshatching, parallel lines or arrangements of dots. This uniform pattern can extend over the entire substrate surface, including over the regions in which the facestock film is cut to produce labels and/or over one or more matrix regions. This is an easy and cheap way of printing the material comprising a VOC scavenger and it means that the pattern of the material comprising a VOC scavenger does not have to be aligned exactly to the position of the labels or the label-forming regions. As the waste facestock film will only include portions of the material comprising a VOC scavenger and will also include regions that are free from the material, less VOC scavenger will be wasted compared to films that have a continuous coating of the material comprising a VOC scavenger, such as those created by aqueous flood coating. This can significantly reduce the cost of producing the labels.

The region of the substrate surface that is free from any material comprising a VOC scavenger may entirely cover the region of the facestock film at which one or more cuts are made during the formation of the labels. The region of the substrate surface that is free from any material comprising a VOC scavenger may entirely cover the matrix region of the substrate. The region of the substrate surface that is free from any material comprising a VOC scavenger may optionally extend beyond the region of the facestock film at which one or more cuts are made during the formation of the label, and/or beyond the matrix region. Thus, the region of the substrate surface that is free from any material comprising a VOC scavenger may extend over the matrix region of the facestock film, defined by cutting the facestock film at the predetermined regions, such that no VOC scavenger is present on the matrix waste.

This embodiment requires the application of the material comprising a VOC scavenger to align with the position of the label-forming regions. However, this also means that no VOC scavenger is lost as part of the matrix waste during the creation of the labels.

The VOC affected by the VOC scavenger may be ethylene, acetaldehyde, Gibberellins (GA), for example GA4GA7 and GA3; cytokinins, such as CPPU and kinetin; Auxins, such as 1-naphthalenacetic acid (NAA), 2,4-D, 3-indoleacetaldehyde acid (IAld), 3-indoleacetic acid (IAA), 3-indolepyruvic acid (IPA) and indolebutanoic acid (IBA); and Inhibitors/Retardants, such as abscisic acid (ABA), ancymidolm, carbaryl, chlormequat, chloro IPC, daminozide, flurprimidol, hydrogen cyanamide (H2CN2), mefluidide, mepiquat chloride, paclobutrozol, prohexadione calcium, and succinic acid (SADH). Preferably, the VOC is ethylene and so the VOC scavenger is an ethylene scavenger.

The material comprising a VOC scavenger may comprise VOC scavenging particles held within a binder, as discussed in GB 1508068.2. Ethylene scavenging particles may comprise a sorbent, which may be a microporous material such as a zeolite, sepiolite or diatomite, which may be ZSM5, or a clay. The ethylene scavenging particles may be doped, for example with a metal such as palladium, as discussed in WO2011/001186.

The binder may comprise acrylic and acrylic acid polymers and co-polymers, acrylates, urethanes, urethane acrylates, isocyanates, epoxides, styrene butadiene rubbers, cyclised rubbers, chlorinated rubbers, styrene butadiene/maleic anhydride copolymers, styrene acrylates, ink binders, cellulosic materials, cellulose acetate, cellulose acetate alkyrate (e.g. butyrate and propionate), polyvinylbutyral, polyvinyl formal, polyvinylacetate, polyvinyl alcohol, nitrocellulose, ethylcellulose, carboxymethyl cellulose ethylhydroxyethyl cellulose, hydroxypropylcellulose, PvOH, polyethylene imine, melamine formaldehyde, urea formaldehyde, terpene resins, alkyd resins, phenolic resins, rosin, ester rosin, linseed oil, silicone resins, unsaturated polyester resins, saturated polyester resins, EVA, starches, polyhydroxyalkanoates, polyamides, polyimides, polyamide imides, PvdC, PvB and compatible mixtures of two or more thereof. The binder may be free from ammonia.

The VOC scavenging particles are preferably protuberant from the binder, in that they extend out from the surface of the binder layer. They may extend beyond the thickness that the binder layer would be if the particles were not present. They may extend beyond the thickness of the binder layer present between particles, when the particles are present in the layer. The particles may still be covered by a thin layer of binder, which can anchor them within the binder layer but still allows the VOCs to reach the VOC scavenger particles. Alternatively, some of the particles may be exposed such that no binder layer is present over part of their surface, although the term “protuberant” does not necessarily require this.

This protuberance can improve the efficiency with which the VOC is removed from the environment, as it can increase the surface area of the VOC scavenger in contact with the environment. The protuberance can also improve the kinetics of the reaction, as the VOC does not have to pass through large amounts of binder material to reach the VOC scavenger.

The protuberance can be created in a number of ways, such as using a high concentration of the VOC scavenger in the binder layer, by using a small amount of a binder material and/or by selecting the size of the scavenger particles with reference to the binder layer thickness, such that it is greater in at least one dimension than the binder layer. The binder layer, with and/or without the particles present, may have a thickness of from 10 to 90%, preferably from 25 to 75% of the particle diameter.

The use of a thin binder layer, such that the diameter of the particles is greater than the thickness of the binder layer with and/or without the particles, can also improve the optical properties of the film, such as transparency.

If a high amount of particles within the binder is used, the particles may be in contact with each other along the axis perpendicular to the surface of the substrate, between the substrate and the surface of the binder layer, in a stacking arrangement. More than one particle may therefore be present in the distance between the surface of the substrate and the surface of the binder. Both the thickness of the binder including the particles and the thickness that the binder would be if the particles were not present may be greater than the particle size of the VOC scavenger in this embodiment.

The concentration of the VOC scavenger in the material comprising the VOC scavenger may be between 0.0001 and 50 gm-2, preferably between 0.1 and 5 gm-2. The ratio of the VOC scavenger to the binder may be between 200:1 and 1:200, preferably between 30:1 and 1:30. This provides an even distribution of the VOC scavenger, as well as reducing dusting and increasing adhesion to the film substrate. Higher ratios can be used to increase the exposure of the VOC scavenger to the environment, thereby increasing the rate of reaction with the VOC.

Particle size may mean any one or more of d1-99, for example d10, d50 or d90. The arithmetic mean particle size (or diameter) may be used.

The substrate web is preferably a polymer film, such as a biaxially orientated polypropylene film. The substrate web may be transparent, opaque or translucent and may be white, colourless, coloured or metallised. If the substrate web is opaque or translucent, this can provide a contrast with any print design applied to the substrate web, or with the surface to which the label is applied. If the substrate web is transparent, the material comprising a VOC scavenger can be viewed from both sides of the label and so any visible changes can be easily seen.

The film or the binder layer may comprise one or more functional materials for other purposes in relation to the functional or aesthetic characteristics of the film. Suitable functional materials may be selected from one or more of the following, mixtures thereof and/or combinations thereof: UV absorbers, dyes; pigments, colorants, metallised and/or pseudo-metallised coatings; lubricants, anti-static agents (cationic, anionic and/or non-ionic, e.g. poly-(oxyethylene) sorbitan monooleate), anti-oxidants (e.g. phosphorous acid, tris(2,4-di-tert-butyl phenyl) ester), surface-active agents, stiffening aids, slip aids (for example hot slips aids or cold slip aids which improve the ability of a film to slide satisfactorily across surfaces at about room temperature, e.g. micro-crystalline wax); gloss improvers, prodegradants, barrier coatings to alter the gas and/or moisture permeability properties of the film (such as polyvinylidene halides, e.g. PVdC); anti-blocking aids (for example microcrystalline wax, e.g. with an average particle size from about 0.1 to about 0.6 μm); tack reducing additives (e.g. fumed silica, silica, silicone gum); particulate materials (e.g. talc); plasticisers; additives to increase COF (e.g. silicon carbide); additives to remove malodorous materials from the surrounding environment; additives to improve ink adhesion and/or printability, additives to increase stiffness (e.g. hydrocarbon resin) and additives to increase shrinkage (e.g. hard resin).

The facestock film may further comprise a barrier layer, which extends over the material comprising a VOC scavenger and protects it during use. The barrier layer is preferably not removable from the facestock film. The material comprising a VOC scavenger may be between the substrate web and the barrier layer. The barrier layer preferably prevents compounds that are detrimental to the VOC scavenger from passing through it, but allows the relevant VOC to reach the VOC scavenger. The barrier layer may also protect the VOC scavenger from dusting and may improve the aesthetics, heat sealability, printability or peelability of the film.

For example, VOC scavengers such as zeolites are sensitive to moisture, if the VOC scavenger comprises a zeolite, the barrier layer may therefore act to prevent water from reaching the zeolite, while still allowing ethylene to pass through the barrier layer.

Additionally or alternatively, the barrier layer may reduce the level of migration of undesirable constituents from the VOC scavenger. This can prevent such constituents contacting the contents of a package, such as a foodstuff, thereby enabling compliance with food contact regulations.

The barrier layer may be a continuous coating and may be formed from a polymer or a non-woven material. The barrier may be a polyolefin and further may be made from polyethylene fibres. Tyvek (a flashspun high-density polyethylene fibre material) is a suitable barrier material.

A seal may form between the barrier layer and the substrate surface in the region of the substrate surface that is free from the material comprising a VOC scavenger. This can encapsulate the material comprising a VOC scavenger between the substrate web and the barrier layer, thereby ensuring that any compounds in the environment that are detrimental to the VOC scavenger, such as water in the case of zeolites, cannot reach the scavenger. This may also prevent migration of constituents of the VOC scavenger.

At least part of the region of the substrate surface that is free from the material comprising a VOC scavenger may comprise a material that enhances the sealing between the substrate web and the barrier layer. This can increase the seal strength, thereby reducing the chance that the barrier layer will be removed from the facestock film during use, which would expose the material comprising a VOC scavenger. This can also decrease the risk that compounds that are detrimental to the VOC scavenger will reach it, or that the VOC will escape into the environment. Suitable materials include, but are not limited to, polyethyleneimine, polyurethane, polyacrylic acids, polyvinylalcohol, polyvinypyrrolidone, polyisocyanates and polyaziridines.

The region of the substrate surface that is free from the material comprising a VOC scavenger may be flush with the material comprising a VOC scavenger. This can be due to the application of a material to said region of the substrate surface, such as a material that enhances the sealing between the substrate surface and the barrier layer. Having the two regions flush with one another can improve the sealing of the barrier layer to the region of the substrate surface.

The facestock film may further comprise a printed design formed using an ink. The ink may be applied to the substrate web and/or the barrier layer. The ink can be applied to the surface of the substrate web comprising the material that comprises a VOC scavenger, or the surface opposite said surface. The inks may be low migration and/or food contact inks. This can result in different designs on either side of the label if the substrate web is opaque or translucent. If the substrate web is transparent, the design may be the same when viewed from either side of the label. When the label is applied to the inside of a packaging, the print may therefore be visible from the outside of the packaging.

The pattern of the material comprising a VOC scavenger may be incorporated into the printed design. In other words, the visual effect or pattern created by the material comprising a VOC scavenger and the regions free from the material may form part of the overall label design, in combination with the printed design. This can create a level of complexity in the visual effects formed. The material comprising a VOC scavenger may provide desirable optical and/or haptic effects.

The material comprising a VOC scavenger is preferably present on one surface of the substrate web. The substrate web may also have an adhesive layer on one surface, which may be opposite the surface to that which the material comprising a VOC scavenger is applied. This means that when the facestock film is applied to the inside of a packaging, the material comprising a VOC scavenger is orientated towards the inside of the packaging.

The adhesive may be a pressure sensitive adhesive and may be a low migration and/or a food contact adhesive. The adhesive may also be of sufficient transparency to enable any print to be visible through it. If a printed design is applied to the surface of the substrate web opposite that to which the material comprising a VOC scavenger is applied, the adhesive may extend over at least part of the printed design. A release liner may then be adjacent the adhesive.

The region of the substrate surface that is free from the material comprising a VOC scavenger may be positioned between the material comprising a VOC scavenger and another component of the facestock film, such as a printed ink pattern. This can act to isolate the material comprising a VOC scavenger from the other component. In other words, the region of the substrate surface that is free from the material comprising a VOC scavenger may separate the material comprising a VOC scavenger from another component of the facestock film. This can be used to provide a specific visual effect, or to minimise potential contamination and/or poisoning of the VOC scavenger.

The other component from which the material comprising a VOC scavenger may be isolated can be an active material that is different to the VOC scavenger material. The active material may be any material that interacts with its surrounding environment. For example, the active material may be an ethylene scavenger, an oxygen scavenger, a moisture scavenger, a temperature indicator, a moisture indicator or a material that is sensitive to oxidising agents, reducing agents, carbon dioxide, ammonia, pH and/or light, such as UV light.

This active material may also be on a surface of the substrate web, which may be the same surface as that comprising the material comprising a VOC scavenger. The separation of the material comprising a VOC scavenger and the active material may be necessary to prevent contamination and/or poisoning of one or both of the materials or to provide a specific visual effect. Additionally, the two materials may require different conditions to function, for example they may be sensitive to different compounds and so may require different barrier layers or binders.

The active material may also be applied in a pattern, which preferably corresponds to the pattern of the material comprising a VOC scavenger. The pattern of the active material may also be incorporated into the print design, as with the material comprising a VOC scavenger. The active material may provide desirable optical and/or haptic effects.

The label facestock film may further comprise cuts through at least part of the facestock film in order to create labels. The cuts may extend around at least one of the at least one label-forming regions, thereby separating said label-forming regions from at least one of the at least one matrix regions and creating a matrix waste. Preferably, cuts are made around all of the label-forming regions.

According to a second aspect of the present invention, there is provided a labelstock comprising the label facestock film as discussed above and a release liner. Alternatively, the facestock may be a linerless facestock.

According to a third aspect of the present invention, there is provided a label produced using the label facestock film or the labelstock discussed above. The label is formed from the facestock film or the labelstock by cutting the film in the regions intended to be cut, which preferably include a region that is free from the material comprising a VOC scavenger. The cuts can extend around the label-forming region, thereby separating the label-forming region and the matrix region of the film. The formation of the labels may create a matrix waste product.

According to a fourth aspect of the present invention, there is provided a packaging including the label facestock film, the labelstock or the label discussed above. This provides a low-cost packaging that includes a VOC scavenger, as including a label facestock film, a labelstock or a label having a VOC scavenger is significantly cheaper than creating a packaging entirely out of a film including a VOC scavenger. The label facestock film, the labelstock or the label can also be positioned as appropriate on the packaging, such that it is easily visible and can be applied at the appropriate time during its manufacture.

The label facestock film, the labelstock or the label may be applied to a polymeric web that is to be used as a flow wrap. The label facestock film, the labelstock or the label could be applied to the surface of the web that would ultimately form the inside of the flow wrapped pack.

The label facestock film, the labelstock or the label may be applied to a polymeric web that is used as a lidding film for a tray, where the label facestock film, the labelstock or the label could be applied to the surface of the web that would be orientated towards the inside of the lidded tray.

The label facestock film, the labelstock or the label may be applied to a pre-formed tray that forms all or part of a packaging solution or product display.

According to a fifth aspect of the present invention, there is provided a method of manufacturing a label facestock film for producing labels as discussed above, comprising applying a material comprising a VOC scavenger to a substrate web surface such that a region of the substrate surface is free from the material comprising a VOC scavenger. The material comprising a VOC scavenger is applied in a pattern and may be printed onto the substrate surface, using a method such as flexographic printing. Preferably, the region of the substrate surface that is free from the material comprising a VOC scavenger forms at least part of the region of the facestock film at which cuts are made during the formation of the labels and/or forms at least part of the matrix region. The region of the substrate surface that is free from the material comprising a VOC scavenger may entirely cover and/or may extend further than the matrix region and/or the region at which cuts are made during the formation of the labels.

The method may further comprise the step of creating one or more label from the label facestock film by cutting the facestock film in the region of the facestock film intended to be cut, which preferably comprises a region of substrate surface that is free from the material comprising a VOC scavenger. The cuts may extend around a label-forming region, thereby separating the label-forming region from a matrix region. Preferably, cuts are made around all of the label-forming regions of the facestock film.

This method is a method for reducing the cost of manufacturing labels from a label facestock film.

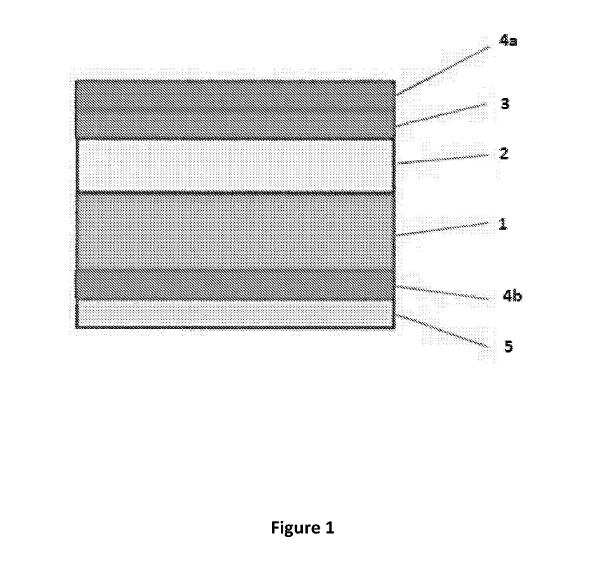

FIG. 1 shows substrate web 1 comprising a polymeric film, onto which a material comprising a VOC scavenger 2 has been printed. The material comprising a VOC scavenger 2 is covered with a functional barrier layer 3. The facestock film comprises two print layers comprising low migration and food contact inks, the first print layer 4a being applied over the barrier layer, while the second print layer 4b is applied to the substrate web 1, on the surface opposite the material comprising a VOC scavenger 2. A pressure sensitive adhesive 5 is applied over the second print layer 4b.

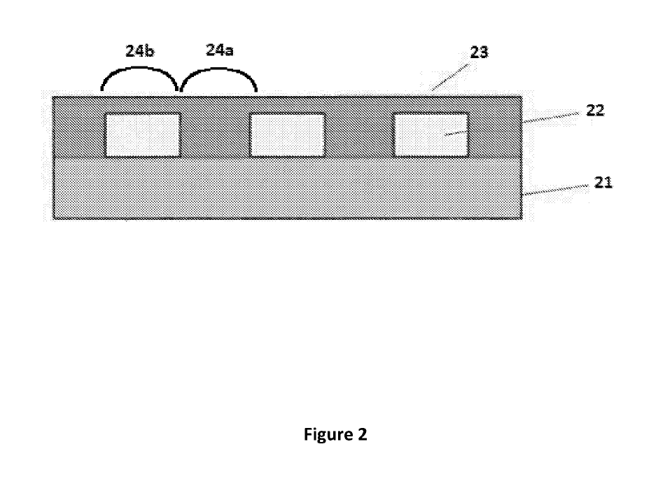

It is to be understood that FIG. 1 only shows the region of the substrate web where the material comprising a VOC scavenger has been applied to the surface. There will therefore be regions adjacent those with the structure shown in FIG. 1 that do not comprise the material comprising a VOC scavenger, i.e. regions that do not comprise VOC scavenger layer 2 shown in FIG. 1. FIG. 2 illustrates how the regions may be arranged relative to one another.

Specifically, FIG. 2 shows substrate web 21 comprising a polymeric film, onto which a material comprising a VOC scavenger 22 has been printed. The material comprising a VOC scavenger 22 has been applied so that there are regions 24a of the substrate surface that are free of the material comprising a VOC scavenger, in contrast to the regions 24b that are in contact with the material comprising a VOC scavenger.

A functional barrier layer 23 has been applied over the material comprising a VOC scavenger 22, thereby protecting it from the surrounding environment. Barrier layer 23 is also in contact with substrate web 21 in the regions 24a of the substrate surface that are free of the material comprising a VOC scavenger. The barrier layer 23 binds to the substrate web 21 in these regions.

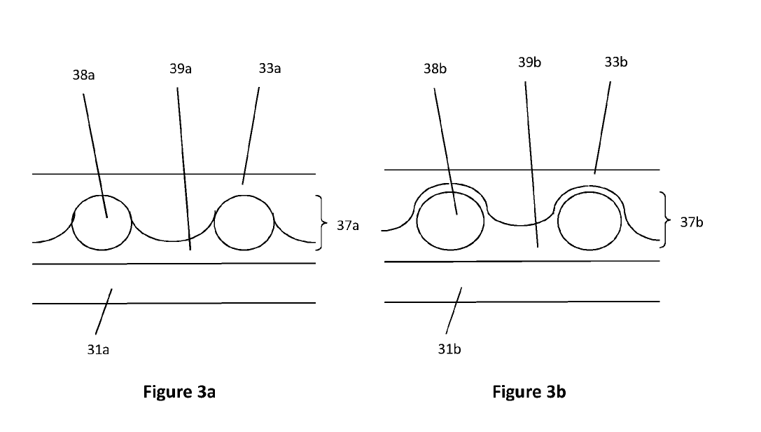

FIG. 3a illustrates a first embodiment of a portion corresponding to region 24b of FIG. 2, which includes the material comprising a VOC scavenger 37a. The material comprising a VOC scavenger 37a comprises particles of a VOC scavenger 38a and a binder 39a. The material comprising a VOC scavenger 37a is located on a substrate web 31a and a functional barrier layer 33a has been applied over the material comprising a VOC scavenger 37a.

The particles of a VOC scavenger 38a are protuberant from the binder 39a, in that the diameter of the particles 38a is greater than the thickness of the binder 39a located between the particles, when the layer includes the particles 38a. The diameter of the particles 38a is also greater than the thickness that the binder 39a would be if the particles 38a were not present. The binder 39a does not extend over the particles of a VOC scavenger 38a, such that the particles are exposed over part of their surface. The barrier layer 33a covers the exposed particles of a VOC scavenger 38a, protecting them from the environment in which the film is placed.

FIG. 3b illustrates a second embodiment of a portion corresponding to region 24b of FIG. 2, which includes the material comprising a VOC scavenger 37b. The material comprising a VOC scavenger 37b comprises particles of a VOC scavenger 38b and a binder 39b. The material comprising a VOC scavenger 37b is located on a substrate web 31b and a functional barrier layer 33b has been applied over the material comprising a VOC scavenger 37b.

The particles of a VOC scavenger 38b are protuberant from the binder 39b, in that the diameter of the particles 38b is greater than the thickness of the binder 39b located between the particles, when the binder layer includes the particles 38b. The diameter of the particles 38b is also greater than the thickness that the binder 39b would be if the particles 38b were not present. The binder 39b extends over the surface of the particles of a VOC scavenger 38b, such that the particles are surrounded by at least a thin layer of binder 39b. The barrier layer 33b covers the material comprising a VOC scavenger 38b, further protecting the particles of a VOC scavenger 38b from the environment in which the film is placed.

The following examples are intended to demonstrate one way of making use of the invention and are not intended to be limiting to the scope of the invention.

### Example 1

An ink containing a scavenging zeolite material (ZSM-5), was formulated using a polyurethane binder (NeoRez R-610™). The ink had a total solids content of 25% and a ratio of zeolite:binder of 5:1. The scavenger was dispersed in water in a solution of 40% solids and sonicated for 3 minutes to remove agglomeration of particles. The scavenger dispersion was then added to the polyurethane binder system to form the ink.

0.5 gsm of a polyurethane primer was applied to a white 50 micron biaxially orientated polypropylene (BOPP) film using a yellow K-bar. The primer was then air-dried prior to printing. The ink containing ZSM-5 was applied to the BOPP film with a surface energy of 38 Dynes/cm (Innovia Films Ltd) using flexographic printing techniques. Specifically, a Flexiproofer 100/UV was used, without utilising the UV capabilities, with a banded anilox roller having two cell volumes (13 cm³/m² and 18 cm³/m²). The ink was applied to the film four times, with air drying between each application. This created a pattern of light and dark bands on the film surface, separated by regions of unprinted film.

Ethylene uptake was measured on duplicate samples and compared to the ethylene uptake of a ZSM-5 sample. The sample of ZSM-5 and each of the printed film samples were placed into separate 20 ml glass headspace vials and crimp sealed with butyl rubber septa. 3000 μl of ethylene (100%) was injected into each of the sealed vials. Corresponding empty vials without any sample were similarly prepared for use as calibration standards. The prepared samples were left to stand at ambient lab conditions for four days prior to GC-FID analysis.

The amount of ZSM-5 in the replicates was calculated so that the results could be directly compared. In order to obtain this value, a sample area of 35 cm2 of the printed film was placed into a ceramic crucible and heated to 750° C. in a muffle furnace for 3 hours. This process burned all organic matter, leaving residual inorganic matter in the crucible. The crucible weight was recorded before and after the heating process and the difference in mass was used to determine the amount of active scavenger on the surface of the film. A reference sample of white BOPP was also heated to ensure that any inorganic matter in the film, such as TiO2, was not included as residual scavenger material.

The total ash content of white 50 micron BOPP was determined as 4.5 gsm and the residual inorganic material for the screen printed material was 7 gsm. Deducting the inorganic material characteristic of the BOPP gave an active content of 2.5 gsm.

The ethylene uptake results are illustrated in Table 1, which includes data that has been normalised based on the amount of ZSM-5 present in the replicates, thereby allowing comparison with the ethylene uptake of ZSM-5 alone. As demonstrated in Table 1, the films containing the patterned print demonstrate a similar ethylene uptake to that of ZSM-5 alone. Thus, the rate of ethylene uptake is not detrimentally affected by including the ZSM-5 in a patterned print.

TABLE 1

| Sample | Ethylene uptake (μl) | Normalised data (μl/g) |
|---|---|---|
| ZSM-5 | 246 | 82000 |
| Print Replicate 1 | 198 | 78749.99 |
| Print Replicate 2 | 212 | 84318.17 |

### Example 2

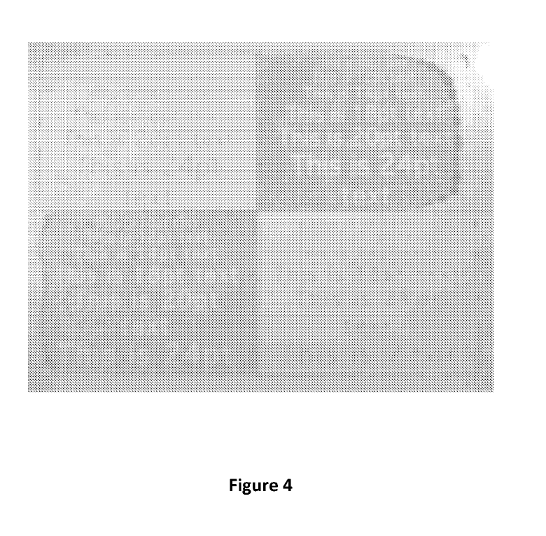

The same ink as used in Example 1 was screen printed on a BOPP film with a surface energy of 38 Dynes/cm (Innovia Films Ltd). The ink was applied using a screen with 120 threads crossing/square inch, creating a checkerboard print pattern including text, as shown in FIG. 4. The print showed 100% adhesion to the base film through a tape test.

Ashing of the sample was conducted using the same method as outlined in Example 1. The residual inorganic material for the screen printed material was 10 gsm and so deducting the inorganic material characteristic of the BOPP gave an active content of 5.5 gsm.

Ethylene uptake of the samples was assessed in the same way as outlined in Example 1 and the results are shown in Table 2, which includes data that has been normalised based on the amount of ZSM-5 present in the replicates, thereby allowing comparison with the ethylene uptake of ZSM-5 alone. As demonstrated in Table 2, while the films containing a patterned print show a reduction in ethylene uptake compared to ZSM-5 alone, this reduction is not sufficient to be problematic. Thus, including the ZSM-5 in a patterned print provides a sufficient level of ethylene uptake in the replicates.

TABLE 2

| Sample | Ethylene uptake (μl) | Normalised data (μl/g) |
|---|---|---|
| ZSM-5 | 246 | 82000 |
| Print Replicate 1 | 279 | 50727.27 |
| Print Replicate 2 | 243 | 44181.81 |

1. A label facestock film comprising a substrate web and a pattern of material comprising a VOC scavenger on a surface of the substrate web, wherein the pattern of the material comprising a VOC scavenger is repetitive and forms a region of said surface that is free from any material comprising the VOC scavenger.

2. A label facestock film according to claim 1, wherein the region of the substrate surface that is free from any material comprising a VOC scavenger forms at least part of a region of the facestock film at which one or more cuts are made during the formation of the labels.

3. The label facestock film according to claim 1, wherein the pattern increases the surface area of the material comprising a VOC scavenger.

4. The label facestock film according to claim 1, wherein the pattern is a uniform pattern such as crosshatching.

5. The label facestock film according to claim 1, wherein the region of the substrate surface that is free from any material comprising a VOC scavenger entirely covers a region of the facestock film at which one or more cuts are made during the formation of the labels.

6. The label facestock film according to 5 claim 1, wherein the VOC scavenger is an ethylene scavenger.

7. The label facestock film according to claim 1, wherein the material comprising a VOC scavenger comprises VOC scavenger particles in a binder layer.

8. The label facestock film according to claim 7, wherein the VOC scavenger particles are protuberant from the binder layer.

9. The label facestock film according to claim 1, further comprising a barrier layer that extends over at least part of the material comprising a VOC scavenger and protects it from at least one compound during use.

10. The label facestock film according to claim 9, wherein the barrier layer is a polymer or a non-woven material.

11. The label facestock film according to claim 9, wherein a seal forms between the barrier layer and the substrate surface in the region of the substrate surface that is free from the material comprising a VOC scavenger.

12. The label facestock film according to claim 11, wherein at least part of the region of the substrate surface that is free from the material comprising a VOC scavenger comprises a material that enhances the sealing between the substrate surface and the barrier layer.

13. The label facestock film according to claim 1, wherein the region of the substrate surface that is free from the material comprising a VOC scavenger is flush with the material comprising a VOC scavenger.

14. The label facestock film according to claim 1, further comprising a printed design formed using an ink.

15. The label facestock film according to claim 14, wherein the pattern of the material comprising a VOC scavenger is incorporated into the printed design.

16. The label facestock film according to claim 1, wherein the region of the substrate surface that is free from the material comprising a VOC scavenger is positioned between the material comprising a VOC scavenger and another component of the facestock film.

17. The label facestock film according to claim 16, wherein the other component is an active material on the substrate surface comprising the material comprising a VOC scavenger.

18. The label facestock film according to claim 1, wherein cuts have been made through at least part of the facestock film in order to create labels.

19. A labelstock comprising the label facestock film of claim 1 and a release liner.

20. A label produced using the label facestock film according to claim 1.

21. A packaging including the label facestock film according to claim 1.

22. A method of manufacturing a label facestock film according to claim 1, comprising:
applying a material comprising a VOC scavenger to a surface of a substrate web such that a region of the substrate surface is free from the material comprising a VOC scavenger.

23. A label produced using the labelstock according to claim 19.

24. A packaging including the labelstock according to claim 19.

25. A packaging including the label according to claim 20.
